(19) United States
(12) Patent Application Publication
(10) Pub. No.: US 2026/0075395 A1
(43) Pub. Date: Mar. 12, 2026

(54) PROVISIONING METHOD AND DEVICE FOR BLUETOOTH MESH NETWORK

(71) Applicant: Realtek Semiconductor Corp., HsinChu (TW)

(72) Inventors: Yanna Zhu, Suzhou City (CN); Zhennan Zhang, Suzhou City (CN); Qi Liu, Suzhou City (CN); Jin Gu, Suzhou City (CN)

(73) Assignee: Realtek Semiconductor Corp., HsinChu (TW)

(21) Appl. No.: 19/006,263

(22) Filed: Dec. 31, 2024

(30) Foreign Application Priority Data
Sep. 10, 2024 (CN) 202411266548.0

(51) Int. Cl. H04W 4/80; H04W 84/18

(52) U.S. Cl. CPC H04W 4/80; H04W 84/18

(57) ABSTRACT

A provisioning method for a Bluetooth mesh network, comprising: on a user device, selecting a plurality of target Bluetooth devices from a plurality of un-provisioned Bluetooth devices; utilizing a plurality of link modules in the user device to establish generic attribute profile links with each of the plurality of target Bluetooth devices; and simultaneously executing a provisioning procedure for each of the plurality of target Bluetooth devices using the plurality link modules, respectively.

### BACKGROUND OF THE INVENTION

### 1. Field of the Invention

The present invention relates to Bluetooth communication, and more specifically, to a provisioning method and device for Bluetooth mesh networks.

### 2. Description of the Prior Art

Bluetooth mesh network is an emerging mesh network technology primarily built on the Bluetooth Low Energy (BLE) wireless communication protocol. The main purpose of Bluetooth mesh networks is to achieve wide-range, high-reliability, and large-scale interconnection of Bluetooth devices, with extensive application prospects in fields such as smart home and industrial automation. Bluetooth mesh networks adopt a mesh topology structure. Any node (i.e., Bluetooth device) within the network can perform relaying, forwarding packets from other nodes, allowing messages to propagate throughout the entire mesh network through broadcasting or relay forwarding. Such architecture significantly extends the point-to-point coverage range of traditional Bluetooth protocols. Bluetooth mesh networks allow any Bluetooth device to act as a routing node, making the network architecture more flexible and extensible, overcoming the range limitations of traditional Bluetooth networks, and thus particularly suitable for scenarios requiring large-scale deployment.

Despite the many advantages of Bluetooth mesh networks, there are still many aspects that need optimization in practical applications. One of these is the provisioning procedure. In a typical provisioning procedure, only one Bluetooth device can be added to the mesh network at a time. Therefore, when a large number of Bluetooth devices need to be added to the Bluetooth mesh network, the efficiency of the provisioning procedure is considerably low.

### SUMMARY OF THE INVENTION

With this in mind, the present invention proposes a method and device for provisioning a Bluetooth mesh network. In the present invention, multiple link modules of a provisioning device are utilized to achieve parallel mesh network joining for multiple Bluetooth devices. Specifically, a provisioning method of the present invention allows a single provisioning device to simultaneously establish connections with multiple un-provisioned Bluetooth devices and synchronously execute provisioning procedures. The parallel provisioning mechanism significantly improves provisioning efficiency, especially suitable for scenarios requiring large-scale deployment of Bluetooth devices. The provisioning device of the present invention includes multiple link modules, each capable of independently establishing a generic attribute profile (GATT) connection with a Bluetooth device. Through such multi-link architecture, the provisioning device can simultaneously process authentication, key distribution, address assignment, and other provisioning steps for multiple Bluetooth devices. This not only greatly shortens the overall provisioning time but also enhances the feasibility and convenience of large-scale deployment.

According to one embodiment, a provisioning method for a Bluetooth mesh network is provided. The provisioning method comprises: on a user device, selecting a plurality of target Bluetooth devices from a plurality of un-provisioned Bluetooth devices; utilizing a plurality of link modules in the user device to establish generic attribute profile (GATT) links with each of the plurality of target Bluetooth devices; and utilizing the plurality of link modules to simultaneously execute a provisioning procedure for each of the plurality of target Bluetooth devices.

According to one embodiment, a computer-readable storage medium is provided. The computer-readable storage medium stores instructions that, when executed by a processing unit, cause the processing unit to perform a provisioning method for a Bluetooth mesh network, which comprises the following steps: on a user device, selecting a plurality of target Bluetooth devices from a plurality of un-provisioned Bluetooth devices; utilizing a plurality of link modules in the user device to establish generic attribute profile (GATT) links with each of the plurality of target Bluetooth devices; and utilizing the plurality of link modules to simultaneously execute a provisioning procedure for each of the plurality of target Bluetooth devices.

According to one embodiment, a provisioning device for a Bluetooth mesh network is provided. The provisioning device comprises: a plurality of link modules, a storage unit and a processing unit. The storage unit is utilized for storing program code. The processing unit is utilized for executing the program code to perform the following operations: based on a user operation, selecting a plurality of target Bluetooth devices from a plurality of un-provisioned Bluetooth devices; utilizing the plurality of link modules to establish generic attribute profile (GATT) links with each of the plurality of target Bluetooth devices; and utilizing the plurality of link modules to simultaneously execute a provisioning procedure for each of the plurality of target Bluetooth devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a provisioning device and architecture for a Bluetooth mesh network according to one embodiment of the present invention.

FIG. 2 illustrates a flow chart of a provisioning method for a Bluetooth mesh network according to one embodiment of the present invention.

FIG. 3 illustrates sub-steps of a provisioning method for a Bluetooth mesh network according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment”, “an embodiment” or “some embodiments” means that a particular feature, structure or characteristic described in connection with the embodiment or example is included in at least one embodiment of the present embodiments. Thus, appearances of the phrases “in one embodiment”, “in an embodiment” or “in some embodiments” in various places throughout this specification are not necessarily all referring to the same embodiment(s). Furthermore, the particular features, structures or characteristics may be combined in any suitable combinations and/or sub-combinations in one or more embodiments.

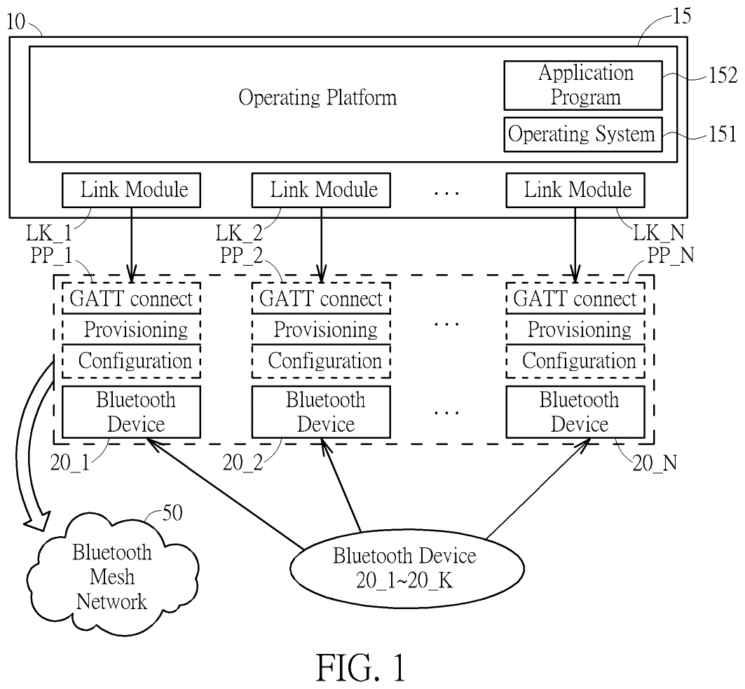

To improve provisioning efficiency for multiple Bluetooth devices joining the mesh network, the present invention proposes a parallel mesh network joining mechanism for multiple Bluetooth devices. Please refer to FIG. 1, which illustrates a provisioning device and related architecture for a Bluetooth mesh network according to one embodiment of the present invention. As shown in the figure, a user device 10 (e.g., smartphone, tablet computer, laptop, or device with Bluetooth connectivity capability) includes an operating platform 15 and multiple link modules LK_1-LK_N. The user device 10 can be a central device as defined in the Bluetooth Low Energy (BLE) protocol. The operating platform 15 of the user device 10 is implemented through an operating system 151 and an application 152 running on the operating system 151. Users can implement parallel mesh network joining for multiple Bluetooth devices by operating the application 152, to form a new Bluetooth mesh network 50 with Bluetooth devices 20_1-20_K, or joining the Bluetooth devices 20_1-20_K to an existing Bluetooth mesh network 50. Specifically, the Bluetooth devices 20_1-20_K can be peripheral devices as defined in the BLE protocol, such as, smart bulbs, smart locks, Bluetooth speakers, temperature sensors, curtain controllers, health monitoring devices, and/or various smart home devices. Additionally, the operating platform 15 and link modules LK_1-LK_N can be implemented by executing pre-programmed software or firmware on specific/non-specific hardware. For example, the link modules LK_1-LK_N can be implemented by running specific software or firmware (e.g., program codes stored in a storage unit) on a Bluetooth chip. The operating platform 15 can be a processor running specific software or firmware (e.g., program codes stored in a storage unit) on the user device 10. Alternatively, the link modules LK_1-LK_N and operating platform 15 can be implemented in pure hardware form.

Within the Bluetooth mesh network 50, each device is called a node, collectively forming a decentralized network structure. Among these, nodes can be further categorized based on their types: 1) relay node: a Bluetooth device capable of message forwarding; 2) low power node: a power-saving type Bluetooth device; 3) friend node: a Bluetooth device assisting low power nodes; 4) proxy node: a device acting as a proxy between nodes and the network.

Before the provisioning procedure begins, un-provisioned Bluetooth devices 20_1-20_K may first send BLE advertisement packets, declaring their support for Generic Attribute Profile (GATT) provisioning services. The GATT provisioning service allows provisioning devices with provisioning capabilities, such as the user device 10, to establish connections with un-provisioned Bluetooth devices and initiate the provisioning procedure. Alternatively, un-provisioned Bluetooth devices 20_1-20_K may send mesh beacons indicating their un-provisioned status, thus allowing another Bluetooth mesh network node with provisioning capabilities to provision them via mesh bearer.

When the user device 10 scans and detects un-provisioned Bluetooth devices 20_1-20_K, the user can select one or more Bluetooth devices from the Bluetooth devices 20_1-20_K to form or join the Bluetooth mesh network 50 by operating the application 152 running on the user device 10. In a single user operation, a number of Bluetooth devices that can participate in parallel mesh network joining is associated with a number of link modules LK_1-LK_N. For example, if the user device 10 has “k” link modules, it can provision “k” Bluetooth devices simultaneously. In this embodiment, assume that Bluetooth devices 20_1-20_N from the Bluetooth devices 20_1-20_K are selected by the user for mesh network joining. After the Bluetooth devices to be joined to the mesh network are selected by the user, the operating platform 15 will activate link modules LK_1-LK_N based on commands sent by the application 152, inviting the Bluetooth devices 20_1-20_N to join the mesh network respectively, and establishing GATT links with each corresponding one of the Bluetooth devices 20_1-20_N. Through the GATT links between each of the Bluetooth devices 20_1-20_N, the user device 10 would simultaneously conduct provisioning procedures PP_1-PP_N for each of the Bluetooth devices 20_1-20_N.

Each of the provisioning procedures PP_1-PP_N includes at least a GATT connect operation, a provision operation, and a configuration operation. First, the GATT connect operation is an initial step of the provisioning procedures PP_1-PP_N. In this step, each of the Bluetooth device 20_1-20_N communicates with the user device 10 through their respective GATT links, responding to the invitation from the user device 10, thereby establishing point-to-point connection with the user device 10 respectively. As such, the user device 10 can conduct one-to-one communication with each of the Bluetooth devices 20_1-20_N and begin initial setup.

In the provision operation, the user device 10 will authenticate each of the Bluetooth devices 20_1-20_N through link modules LK_1-LK_N to verify a device identity of each of the Bluetooth devices 20_1-20_N. Moreover, the user device 10 will also perform network key (e.g., Netkey) distribution, providing network keys to each of the Bluetooth devices 20_1-20_N, allowing the Bluetooth devices 20_1-20_N to use the network keys to encrypt or decrypt messages exchanged within the Bluetooth mesh network 50. Additionally, the provision operation will also perform address assignment, assigning at least one unicast address within the Bluetooth mesh network 50 to each of the Bluetooth devices 20_1-20_N. The unicast address is unique and employed for the purpose of routing messages sent to and from the Bluetooth devices 20_1-20_N. Furthermore, during the provision operation, the user device 10 and the Bluetooth devices 20_1-20_N may also generate device-specific keys, which can be employed for subsequent device management and configuration operations. Once the provision operation is completed, the Bluetooth devices 20_1-20_N obtain network keys and unicast addresses, allowing them to join the Bluetooth mesh network 50 using the obtained network keys, listen to network broadcasts, and communicate with other devices, becoming nodes in the Bluetooth mesh network 50.

In the configuration operation, the user device 10 will configure device functions of the Bluetooth devices 20_1-20_N through the link modules LK_1-LK_N. For example, the user device 10 reads device data (such as device composition data) from each of the Bluetooth devices 20_1-20_N to determine models supported by the Bluetooth device, manufacturer information, and/or supported node types. Based on the device data, node types, operations, functions, and/or modes of Bluetooth devices 20_1-20_N are set (e.g., disabled or enabled). According to application(s) that each of the Bluetooth devices 20_1-20_N needs to support, the user device 10 assigns one or more application keys required for the Bluetooth device. Moreover, the user device 10 may also define publish and subscribe settings, instructing each of the Bluetooth devices 20_1-20_N which groups to send messages to and which group messages to listen to.

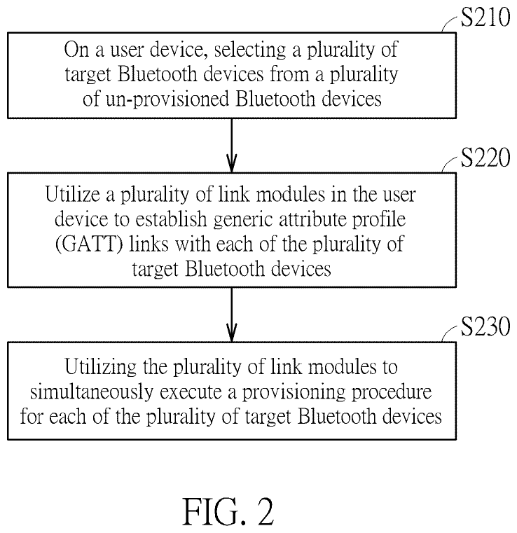

FIG. 2 illustrates a flow chart of a provisioning method for a Bluetooth mesh network according to one embodiment of the present invention. As shown in the figure, the provisioning method of the present invention includes the following steps:
S210: on a user device, selecting a plurality of target Bluetooth devices from a plurality of un-provisioned Bluetooth devices;
S220: utilize a plurality of link modules in the user device to establish generic attribute profile (GATT) links with each of the plurality of target Bluetooth devices; and
S230: utilizing the plurality of link modules to simultaneously execute a provisioning procedure for each of the plurality of target Bluetooth devices.

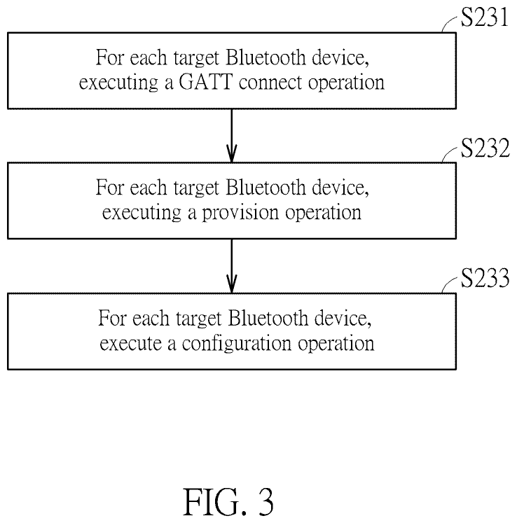

Furthermore, step S230 includes sub-steps shown in FIG. 3:
S231: For each target Bluetooth device, executing a GATT connect operation;
S232: For each target Bluetooth device, executing a provision operation; and
S233: For each target Bluetooth device, execute a configuration operation.

Since the principles and specific details of the above steps have been explained in detail through previous embodiments, they will not be repeated here. It should be noted that the above flow/procedure can be better implemented by adding other additional steps, or making appropriate modifications and adjustments, to better implement the provisioning procedure and properly manage each node and message exchange in the Bluetooth mesh network.

Moreover, in one embodiment, if the number of Bluetooth devices selected by the user for mesh network joining is greater than the number of link modules LK_1-LK_N in the user device 10, the advantage of parallel mesh network joining can be used to accelerate the entire process. For example, if the number of link modules in the user device 10 is “6” (e.g., LK_1-LK_6), and the number of Bluetooth devices selected by the user for network joining is “10” (e.g., 20_1-20_10), the link modules LK_1-LK_6 would only handle the provisioning procedures for “6” Bluetooth devices of the Bluetooth devices 20_1-20_10 initially. However, since the link modules LK_1-LK_6 perform provisioning procedures based on a multi-threading approach, as long as any one of the link modules LK_1-LK_6 completes the current provisioning procedure being processed, it can start the provisioning procedure for a next Bluetooth device, without waiting for all of link modules LK_1-LK_6 to complete the ongoing provisioning procedures.

In summary, the present invention proposes an innovative provisioning method and device for a Bluetooth mesh network, implementing parallel mesh network joining for a plurality of Bluetooth devices by utilizing multiple link modules. The method significantly improves provisioning efficiency, especially suitable for large-scale deployment scenarios. The key features of the present invention include: utilizing a plurality of link modules of the provisioning device to simultaneously establish connections with multiple un-provisioned Bluetooth devices, and executing provisioning procedures in parallel, thereby completing key steps such as device authentication, key distribution, and address assignment. Such parallel handling mechanism not only greatly reduces provisioning time but also enhances the feasibility of large-scale deployment. Therefore, the present invention provides a practical solution for rapid deployment and expansion of Bluetooth mesh networks, expected to play an important role in Internet of things applications, such as, smart cities and smart homes, promoting the application and development of Bluetooth technology in broader fields.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A provisioning method for a Bluetooth mesh network, comprising:
on a user device, selecting a plurality of target Bluetooth devices from a plurality of un-provisioned Bluetooth devices;
utilizing a plurality of link modules in the user device to establish generic attribute profile (GATT) links with each of the plurality of target Bluetooth devices; and
utilizing the plurality of link modules to simultaneously execute a provisioning procedure for each of the plurality of target Bluetooth devices.

2. The provisioning method of claim 1, wherein the step of simultaneously executing the provisioning procedure for each of the plurality of target Bluetooth devices comprises:
for each target Bluetooth device:
executing a GATT connect operation;
executing a provision operation; and
executing a configuration operation.

3. The provisioning method of claim 2, wherein the step of executing the provision operation for the target Bluetooth device comprises:
assigning at least one network key and at least one unicast address to the target Bluetooth device.

4. The provisioning method of claim 2, wherein the step of executing the configuration operation for the target Bluetooth device comprises:
setting operation, function, and/or mode of the target Bluetooth device.

5. A computer-readable storage medium storing instructions that, when executed by a processing unit, cause the processing unit to perform a provisioning method for a Bluetooth mesh network, comprising the following steps:
on a user device, selecting a plurality of target Bluetooth devices from a plurality of un-provisioned Bluetooth devices;
utilizing a plurality of link modules in the user device to establish generic attribute profile (GATT) links with each of the plurality of target Bluetooth devices; and
utilizing the plurality of link modules to simultaneously execute a provisioning procedure for each of the plurality of target Bluetooth devices.

6. A provisioning device for a Bluetooth mesh network, comprising:
a plurality of link modules;
a storage unit for storing program code;
a processing unit for executing the program code to perform the following operations:
based on a user operation, selecting a plurality of target Bluetooth devices from a plurality of un-provisioned Bluetooth devices;
utilizing the plurality of link modules to establish generic attribute profile (GATT) links with each of the plurality of target Bluetooth devices; and
utilizing the plurality of link modules to simultaneously execute a provisioning procedure for each of the plurality of target Bluetooth devices.

7. The provisioning device of claim 6, wherein the processing unit executes the program code to perform the following operations:
for each target Bluetooth device:
executing a GATT operation;
executing a provision operation; and
executing a configuration operation.

8. The provisioning device of claim 7, wherein the processing unit executes the program code to perform the following operation:
assigning at least one network key and at least one unicast address to the target Bluetooth device.

9. The provisioning device of claim 7, wherein the processing unit executes the program code to perform the following operation:
setting the operation, function, and/or mode of the target Bluetooth device.
